(19) United States
(12) Patent Application Publication
(10) Pub. No.: US 2021/0043174 A1
(43) Pub. Date: Feb. 11, 2021

(54) SYSTEM AND METHOD FOR SEMI-AUTOMATED GUIDED AUDIO PRODUCTION AND DISTRIBUTION

(71) Applicant: Auxbus, Inc., Asheville, NC (US)

(72) Inventors: Dan Radin, Asheville, NC (US); Ryan DuVal, Asheville, NC (US); Meghan Bausone, Asheville, NC (US); Amber Blue, Asheville, NC (US); Scott Shwarts, Asheville, NC (US)

(73) Assignee: Auxbus, Inc., Asheville, NC (US)

(21) Appl. No.: 16/749,421

(22) Filed: Jan. 22, 2020

Related U.S. Application Data
(60) Provisional application No. 62/884,965, filed on Aug. 9, 2019.

(51) Int. Cl. G10H 1/00; G11B 27/00; G11B 27/031

(52) U.S. Cl. CPC G10H 1/0041; G11B 27/031; G11B 27/007

(57) ABSTRACT

A method for creating a digital audio production. The method includes receiving two or more audio segments, including at least one audio segment that is captured by a sound recording device, receiving user input related to the two or more audio segments, receiving a record plan comprised of a first part that is based on the user input and a second part that is determined automatically based on the user input, and recording the digital audio production from the two or more audio segments based on the record plan.

### CROSS-REFERENCE TO RELATED APPLICATION

This application claims the benefit of U.S. Provisional Patent Application No. 62/884,965, filed on Aug. 9, 2019 and entitled SYSTEM AND METHOD FOR SEMI-AUTOMATED GUIDED AUDIO PRODUCTION AND DISTRIBUTION, which is incorporated herein by reference in its entirety.

### TECHNICAL FIELD

The invention relates generally to audio production and distribution. More particularly, the present invention relates to a system and method of semi-automated guided audio production and distribution.

### BACKGROUND OF THE INVENTION

A variety of technologies exist for recording, editing and publishing audio for use in various output formats, including audiobooks, podcasts, radio, webinars, etc. Certain conventional recording technologies offer the ability to make a combined audio recording of both a host and guest participant simultaneously on a single recording. Other technologies allow each participant (e.g., a host and a remote participant) to each be recorded separately and for separate audio track to be stored locally to each participant's device that contains only his or her audio stream (e.g. one side of a conversation). Typically, subsequently combining local recordings of individual audio streams improves the resulting audio quality compared to audio streams that are created together in real time at the time of recording via internet protocols such as VoIP (voice over internet protocol) or WebRTC (web real-time communication).

Post-production software allows users to improve the quality of the audio, e.g., analyze the audio files, convert the file formats if necessary, split stereo tracks, set panning (left/right balance), perform sound levelling, perform dynamics processing and equalization, remove problem frequencies and reduce noise, etc. This process also includes aligning the audio files, creating fades, trimming silences, inserting padding, creating joiner music, and mixing in background music. Additionally, post-production software offers tools to combine the audio files and create a finished product, e.g., perform final mixdown of the audio. This results in a finished master audio production and a compressed audio file that is suitable for distribution.

Finally, technology exists for distributing the finished audio. Existing distribution platforms host the compressed audio files and utilize metadata describing the audio files (e.g., text descriptions that allow it to be discovered by interested consumers), allowing users to stream or download it for consumption.

### BRIEF SUMMARY OF THE INVENTION

The above and other needs are met by a method for creating a digital audio production. The method includes receiving two or more audio segments, including at least one audio segment that is captured by a sound recording device, receiving user input related to the two or more audio segments, receiving a record plan comprised of a first part that is based on the user input and a second part that is determined automatically based on the user input; and recording the digital audio production from the two or more audio segments based on the record plan.

In some embodiments, the first part of the record plan comprises a chronological ordering of at least a portion of the two or more audio segments in the digital audio production. In some embodiments, the second part of the record plan includes audio processing steps that are determined and configured automatically based on user input. In some embodiments, certain audio processing steps are automatically applied to at least one of the two or more audio segments before the segments are combined. In some embodiments, certain audio processing steps are automatically applied to the digital audio production after the segments are combined. In certain embodiments, additional audio, which may include music, environmental sounds or sound effects may be added to the original audio segment. In certain embodiments, the additional audio may be processed and adjusted for level so as to constitute background while maintaining intelligibility of the primary audio segment content.

According to certain embodiments, the method also includes the step of compressing the digital audio production to form a digital file suitable for digital distribution and then digitally distributing the digital file according to the user input. In certain embodiments, the method includes storing the at least one audio segment captured by the sound recording device to local storage that is local to the sound recording device. The at least one audio segment is then wirelessly transmitted from the local storage to a remote storage. In certain preferred embodiments, the local storage is a memory of the sound recording device.

Certain embodiments of the method include providing a display device configured to display a user interface (UI) and a user input device for receiving the user input. In certain embodiments, the user interface comprises functional elements associated with the two or more audio segments and the position of the functional elements within the UI determines the chronological ordering the two or more audio segments. In certain embodiments, the UI includes a host UI and a host user input device that is configured to receive input from a host. Additionally, the UI includes a guest UI and a guest user input device configured to receive input from one or more guests. According to certain embodiments, the content of the host UI differs from content of the guest UI. In some embodiments, a session invite must be provided to each of the one or more guests before the guest UI is provided to the user. Certain embodiments of the method require receiving user input via the user input device to reposition the functional elements within the UI for modifying the chronological ordering of the two or more audio segments. In certain embodiments of the method, a content guide is displayed in the UI, which content guide displays contextual information associated with the functional elements that are currently displayed in the UI intended to provide guidance to the user in decision-making and execution of creating the objective audio content.

In certain embodiments of the invention, at least two of the two or more audio segments are captured by separate sound recording devices. The two audio segments are preferably stored locally to a local storage of each of the sound recording devices. The two audio segments are then preferably wirelessly transmitted to a remote storage prior to being combined or audio processed.

In certain embodiments, the method requires creating two or more individual episodes of the digital audio production, wherein each episode include a first audio segment that is universal to all of the two or more episodes and separate second audio segments that are unique to each of the two or more episodes. Certain preferred embodiments contemplate modifying the record plan to replace a first audio segment previously provided with a different and newly-provided first audio segment. After the newly-provided first audio segment has replaced the original first audio segment, the method requires re-creating the two or more individual episodes of the digital audio production to include the newly-provided first audio segment. In certain embodiments, the user of the system may be permitted to add, remove, change, re-order, insert, revise or otherwise amend previously published episodes. These amended episodes may automatically update existing instances at all points in the subsequent distribution supply chain without user intervention.

Also disclosed is an audio production and distribution system for creating and distributing a digital audio show that includes two or more related but separate episodes. The system first includes a setup module for receiving show-level user input related to show-level portions of the show that are repeated in each episode. A plan module of the system receives episode-level user input related to episode-level portions that are unique to each episode of the show. The plan module also arranges the show-level portions and episode-level portions according to a record plan. Next, a record module receives recorded show-level audio segments and recorded episode-level audio segments. A Preview module is provided for audio processing recorded audio segments, for ordering and combining the recorded audio segments to form an unprocessed episode, and for audio processing unprocessed episodes to form finished episodes. Lastly, a review module distributes finished episodes.

In order to facilitate an understanding of the invention, the preferred embodiments of the invention, as well as the best mode known by the inventor for carrying out the invention, are illustrated in the drawings, and a detailed description thereof follows. It is not intended, however, that the invention be limited to the particular embodiments described or to use in connection with the apparatus illustrated herein. Therefore, the scope of the invention contemplated by the inventor includes all equivalents of the subject matter described herein, as well as various modifications and alternative embodiments such as would ordinarily occur to one skilled in the art to which the invention relates. The inventor expects skilled artisans to employ such variations as seem to them appropriate, including the practice of the invention otherwise than as specifically described herein. In addition, any combination of the elements and components of the invention described herein in any possible variation is encompassed by the invention, unless otherwise indicated herein or clearly excluded by context.

### BRIEF DESCRIPTION OF THE DRAWINGS

The presently preferred embodiments of the invention are illustrated in the accompanying drawings, in which like reference numerals represent like parts throughout, and in which:

FIG. 1 is a block diagram illustrating setup, plan, and record modules of a semi-automated guided audio production and distribution system according to an embodiment of the present invention;

FIG. 2 is a detail view of a portion of the setup module of FIG. 1;

FIGS. 3 and 4 are block diagrams illustrating a Preview module and a review module, respectively, of the system of FIG. 1;

FIGS. 5-12 are screenshots illustrating a user interface (UI) of the setup module of the system of FIG. 1;

FIGS. 13 and 14 are screenshots illustrating the UI of the plan module of the system of FIG. 1;

FIGS. 15 and 16 are screenshots illustrating the UI of the record module of the system of FIG. 1;

FIG. 17 is a screenshot illustrating the UI of the review module of the system of FIG. 1;

FIG. 18 is a screenshot illustrating a tab area of a website containing the UI of the system of FIG. 1 that includes a recording indicator; and

FIG. 19 illustrates a processor and storage device used in creating a digital audio production according to an embodiment of the present invention.

### DETAILED DESCRIPTION OF THE INVENTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic form in the interest of clarity and conciseness.

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are operatively coupled, e.g., secured or attached or communicatively coupled to one another either directly or indirectly through intervening structures, as well as both moveable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

The terms “audio content” and “audio production” are used throughout this description broadly to include any forms of recorded audio, regardless of the nature of their application or use. Non-limiting examples of “audio content” (and “audio production”) include, but are not limited to, recorded audio used in movies, audiobooks, podcasts, radio, webinars, and the like.

Creating audio content is particularly difficult for small and medium size business users, which may want to use audio to provide business-related content that is easy to consume, e.g., on a mobile device on the go. Such users require a high degree of professionalism with respect to the finished audio and cannot accept low quality results; however, they often do not have the expertise to create a polished audio product and often cannot afford to spend a lot of time doing so themselves. At the same time, hiring a professional production company is typically out of budget for such projects.

A difficulty encountered when an inexperienced user attempts to create audio content using conventional technologies is that there is no end-to-end solution for creating audio content. The inexperienced user often does not know how to create or structure successful audio content from the start or how to take the audio content through post-production (i.e., audio processing and assembly) to create professional quality audio content and get it distributed via a distribution platform.

With respect to planning, inexperienced users typically encounter difficulties from the start of creating audio content, i.e., difficulties are encountered in planning or setting up the audio content (e.g., choosing a format, identifying the segments to be included, sequencing the various segments, choosing related artwork and descriptive teams and titles used in distribution, etc.). Additionally, depending on the type of audio content that is of interest (e.g., interview format), users often encounter additional difficulties unique to that format (e.g., difficulty identifying appropriate participants for the audio content).

In addition to planning challenges, inexperienced users also encounter difficulties while attempting to create (i.e., record) the audio content. Although tools exist to record the audio, such as tools to patch in remote participants, inexperienced users can encounter difficulty with making the recordings, such as accessing scripts or notes to recall topics to be addressed while recording a given segment. Other difficulties include determining how long each segment should last, and identifying and coordinating with guests.

A difficult issue that an inexperienced user will encounter is finishing the audio content in terms of handling post-production editing, processing, and mixing. This is because the output of conventional recording solutions is typically two or more audio files that need to be imported into a separate post-production software for editing and assembling an audio content file. While locally recorded, separate audio files improve the audio quality of the raw input file compared with those captured via internet protocol (e.g., VoIP) and allow for better post-production to take place, this also increases the complexity of the production process. The existing post-production tools, while offering a rich feature set, require a high degree of skill and are time consuming. Thus, an inexperienced user is often faced with taking many hours to remove unwanted noise, apply noise leveling, appropriately align and sequence audio files, incorporate music and fades, etc. These tasks are typically difficult enough that users either produce audio content having sub-optimal audio quality, hire a production assistant or company, or fail to adopt and use the audio medium.

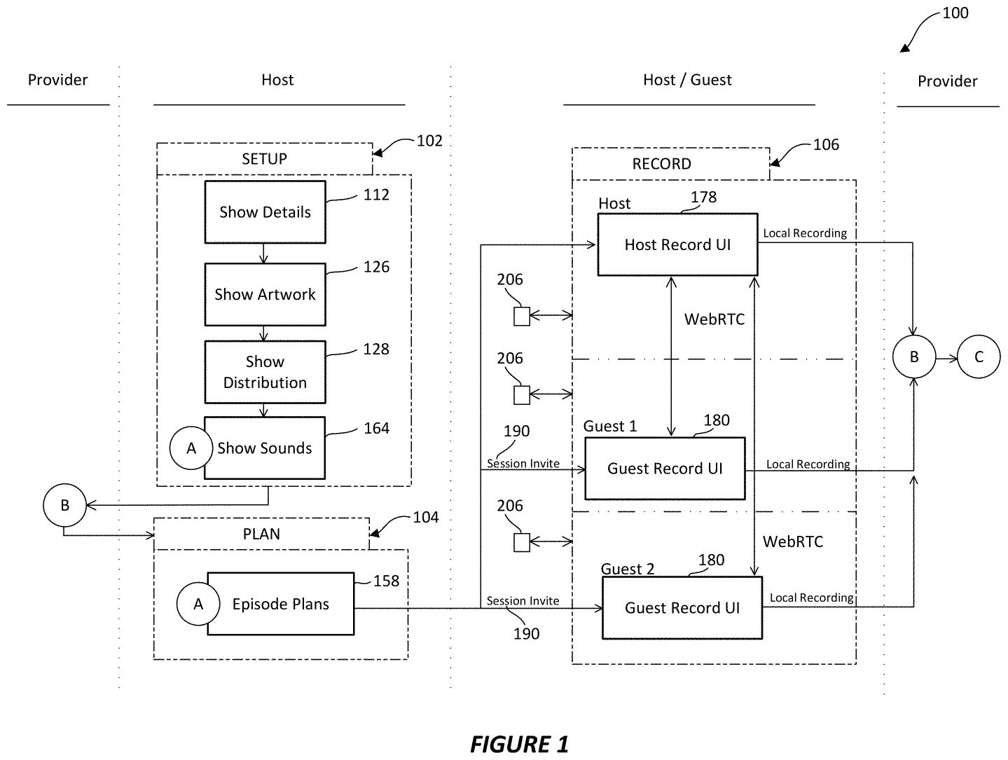

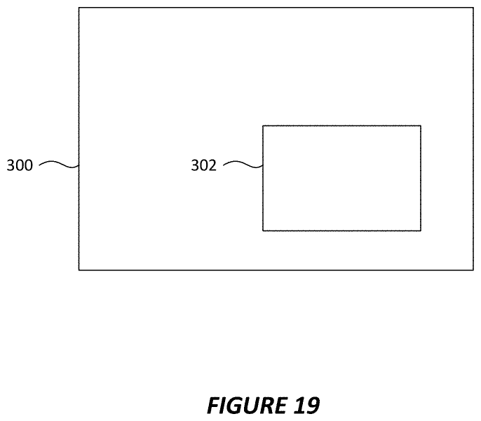

Referring now to FIGS. 1-4 and 19, there is provided a processor 300 and storage device 302, wherein the storage device stores instructions executable by the processor to execute a semi-automated guided audio production and distribution system 100 according to an embodiment of the present invention. The system 100 functions as an end-to-end solution for creating professional-quality audio productions, such as podcasts, in a semi-automated fashion. This system 100 addresses the need for a reasonable level of assistance in creating a polished audio production suitable for business users without the expense that would ordinarily be incurred in hiring a professional to provide that assistance. As such, the system 100 is provided with a dynamic guide that responds to input provided by the user to guide the user through the creation and distribution process. Additionally, certain tasks in the production and distribution process are automatically carried out by the system 100. These tasks may be altered depending on input provided by the user.

As detailed below, the full end-to-end system 100 has several modules that work in conjunction with one another to assist the user in initializing (Setup module 102), planning (Plan module 104), recording (record module 106), post-processing audio (Preview module 108) and then automatically assembling and distributing (Review module 110) an audio production. These modules assist users in: (a) setting up global settings that may be applied to one or more finished audio productions (the overall production may be referred to herein as a “show” and may consist of multiple related but standalone “episodes”), (b) creating an episode plan that plans the content and arrangement of components within individual audio productions (or episodes), (c) creating and recording the content portions of each of the planned episodes, (d) processing those content portions according to an automated post-processing algorithm and according to the global show settings and the episode plan to create finished episodes, and (e) automatically assembling and distributing the finished episodes according to the global show settings.

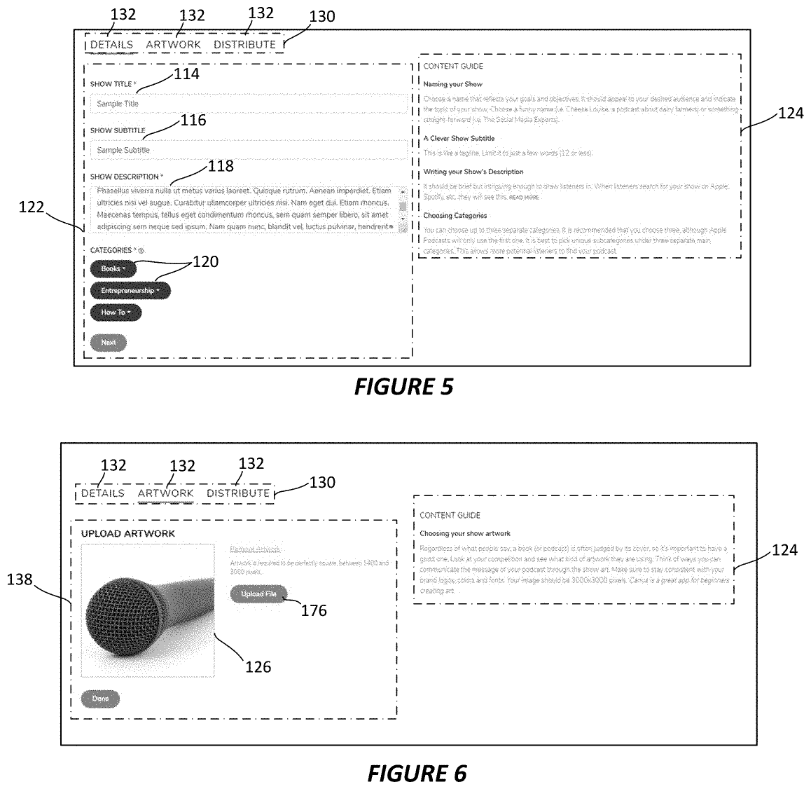

Preferably, users interact with the system via a web-based interface (UI) using a set of UI tools for each module. The system's 100 UI tools may be provided by a central provider service (e.g., cloud hosted service) and are preferably displayed on a user's device (e.g., within a browser in a tabbed format or mobile application). The goal of the UI is to assist inexperienced users in creating professional quality audio content. The UI includes all of the elements needed to guide the user through the setup, planning, recording and launching of the audio production. Screenshots of a UI used in operating the system 100 according to a preferred embodiment are provided in FIGS. 5-17.

Setup Module

With reference generally to FIG. 1 and FIGS. 5-11, the Setup module 102 is first implemented to set global or show-level settings that will preferably be applied to each individual episode. As shown in FIG. 5, these settings include general show details 112, such as the show title 114 and subtitle (if used) 116, a general show description 118 of the show as a whole, and show categories 120 (e.g., keywords, tags, etc.) that are used to classify the show. The description 118 and categories 120 may be configured to allow the user to specify the general type of audio production to be produced (e.g., podcast, audiobook, etc.) as well as the specific type of audio production to be produced (e.g., an interview-type podcast, a talk show-type podcast, a monologue-type podcast, etc.). In certain embodiments, these details are input by the user in an input area 122 via text entry or other fields (e.g., radio button, etc.). In other embodiments, certain show details, such as show title 114 or show description 118 are populated automatically using artificial intelligence (e.g., artificial intelligence that transcribes episode audio and condenses it to a summary format for use as the shown description 118). Additionally, the data entries discussed above are preferably used to automatically populate the audio file metadata used by a distribution platform.

In this module and, preferably, in every other module, a content guide 124 is provided on the same screen as the input area 122. The content guide 124 functions like a user's manual for the system 100 that is automatically turned to the correct section to provide the most relevant information to the user. The information provided in the content guide 124 relates specifically to the information that the user is inputting into the input area 122. Preferably, the content guide 124 automatically updates in response to information provided by the user in the input area 122. For example, it may be preferred for a particular type of audio production to have a title or show description with a length between a minimum length and maximum length (i.e., number of characters). If the user inputs a title or description in the input area 122 that is outside of the recommended range, the content guide 124 may be updated to provide a warning to the user.

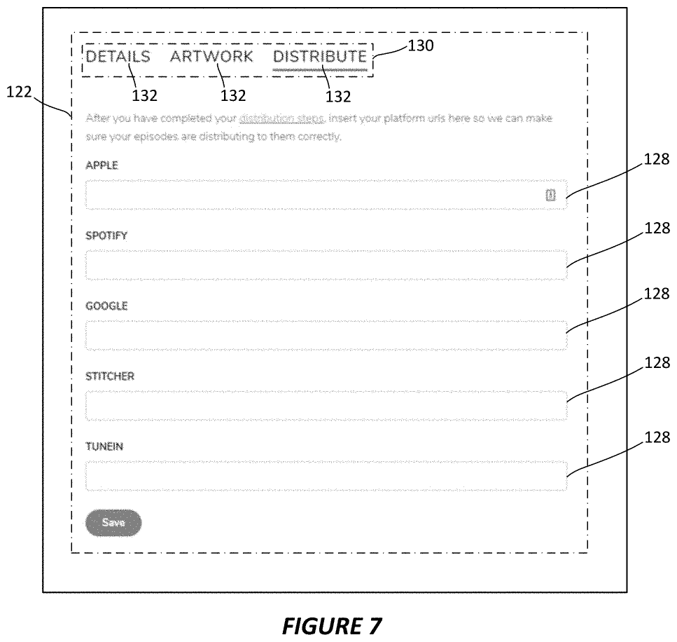

The input area 122 shown in FIG. 6 allows a user to upload show artwork 126 that can be associated with the show. The associated content guide 124 may provide best practices regarding image size, image quality, etc. and may also provide warnings if the uploaded content is outside of the recommended parameters. The input area 122 shown in FIG. 7 allows a user to provide show distribution settings 128 that will be used in automatically distributing the audio production. In this particular case, the audio production is a podcast that may be distributed through various podcast platforms. To automatically distribute a podcast through a particular platform, a user would enter the uniform resource locator (URL) address associated with that user's account on that podcast distribution platform. As discussed below, the system 100 will automatically publish completed podcasts to the platforms using the distribution settings 128.

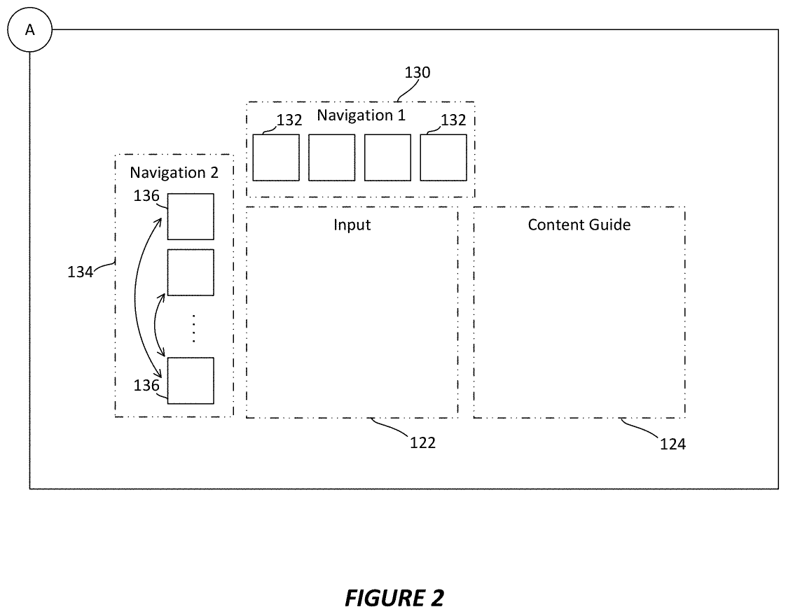

Two sections of the system 100 shown in FIG. 1 are marked with the letter “A”, which indicates that the UI associated with those two portions of the system in this particular embodiment utilize the format shown in FIG. 2. In other embodiments, the UI interface format shown in FIG. 2 could be applied system wide or in connection with additional or other portions (e.g., other modules) of system 100. The UI interface in FIG. 2 includes input area 122 and content guide 124, as discussed above. However, it also includes two navigation sections, including a first navigation section 130 having a first set of interface elements 132 (i.e., functional tiles), which preferably function as navigation buttons, and a second navigation section 134 having a second set of interface elements 136 (i.e., functional tiles), which also preferably function as navigation buttons. First and second navigations sections 130, 134 work together with one another to assist the user in not only navigating at both the show level and at the individual episode level but also in creating and editing at both a show level and individual episode level.

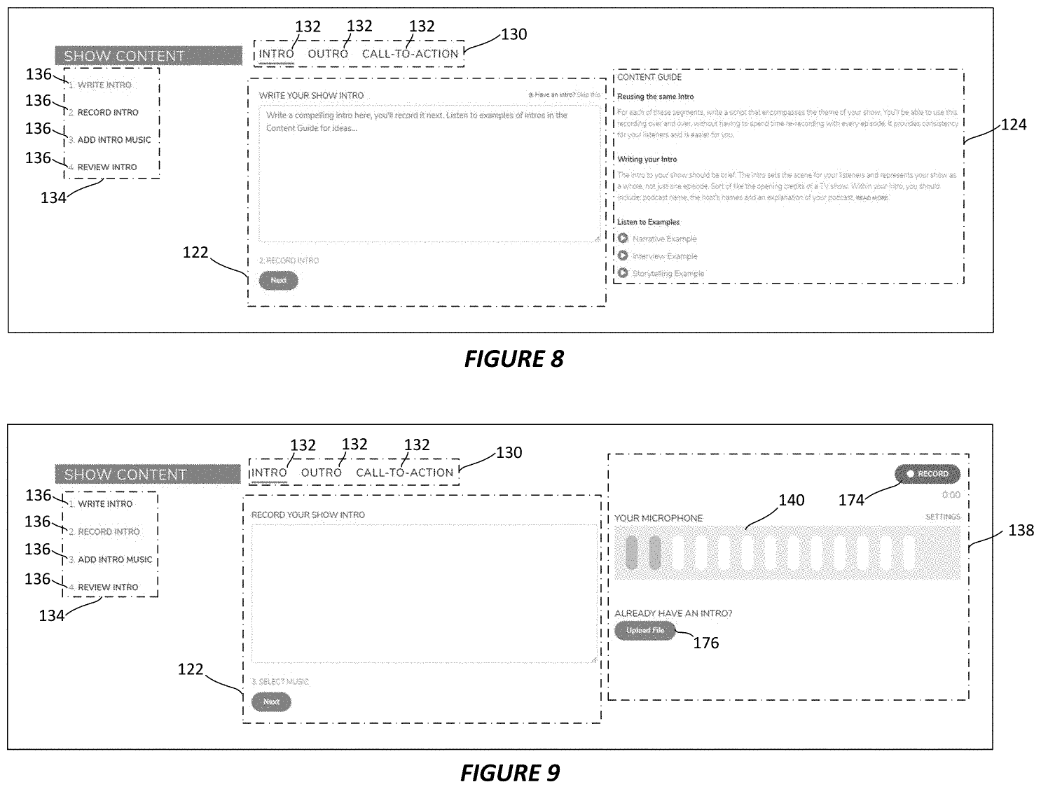

This UI interface format is utilized in inputting globally-applied show sound information 164 (see FIG. 1). For example, illustrated in the embodiment of FIGS. 8-11, the first navigation section 130 contains three functional elements (or first elements 132), INTRO, OUTRO, and CALL TO ACTION (CTA) that are all types of show sounds 164 that are preferably applied automatically and globally across all episodes by the system 100. These three elements 132 correspond to three sections of every podcast where audio is preferably repeated from one episode to the next. When the INTRO first element 132 is selected, the second navigation section 134 contains four functional elements (or second elements 136), WRITE INTRO, RECORD INTRO, ADD INTRO MUSIC, and REVIEW INTRO. These four elements 134 correspond to the four steps required to produce globally-applied show intro audio. If either of the OUTRO or CTA first element 132 were selected in the first navigation section 130 instead of the INTRO first element, the second navigation section 134 would contain different second elements 136 corresponding to the steps required to produce globally-applied show outro or CTA audio.

The content of the input area 122 and content guide 124 change depending on the combination of first element 132 and second element 136 selected. For example, as shown in FIG. 8, this particular combination of selected first element 132 (i.e., INTRO) and second element 136 (i.e., WRITE INTRO) results in a text entry box being provided in the input area 122, where the user can enter notes, a script, etc. that may be used in the creation of the Intro. Additionally, notes related to intros and audio examples are provided in the content guide 124.

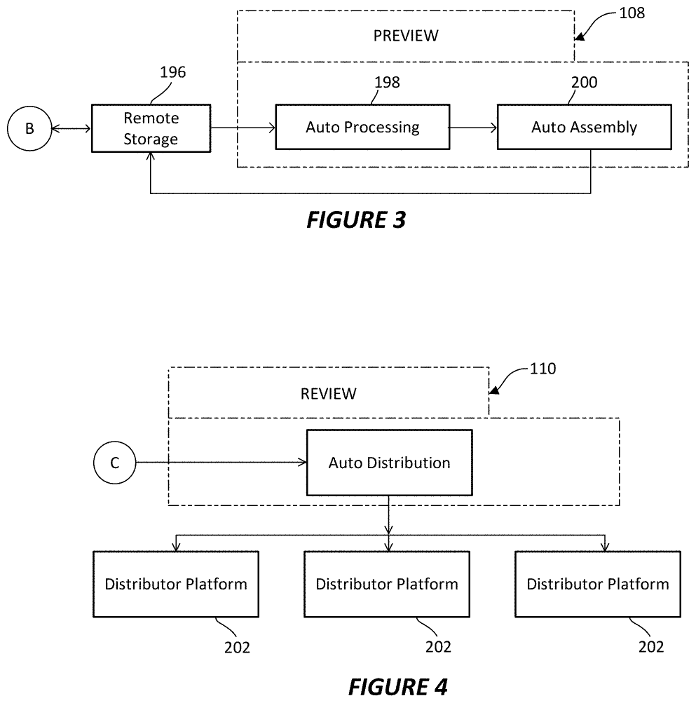

Next, while keeping the first element 132 the same (i.e., INTRO) and selecting the next second element 136 (i.e., RECORD INTRO), the content guide is replaced with an input-output (I/O) area 138 that will allow the user to record the audio for the intro. Input areas are intended to primarily merely receive information or data from the user, whereas I/O area 138 receives information from user but also provides information or data back to the user. The I/O area 138 allows a user to provide audio for use as the intro in two ways. First, the user can upload a previously-created audio file. The user can also record audio by pressing the “record” button 174. The I/O area 138 contains a volume unit meter 140, which provides visual confirmation to the user that their microphone settings are correct and that the microphone is picking up audio signals. Preferably, the system 100 is configured so that the record button only works when audio is detected in order to prevent the user from recording silence. This feature is particularly important for novice content creators to assist them in wasting time and effort trying to record audio when the microphone is not functioning properly. The input area 122, previously populated with text, remains visible in this view so that the user can read that text as they record the intro. By pressing the record button 174, users can record audio directly with their local machine hardware 206 (FIG. 1), including recording devices, microphones, sound cards, local storage, mobile phone. This audio is first stored locally (at least temporarily). If stored to a user device, the audio is automatically and progressively thereafter, streamed to storage 196 (FIG. 3). For example, the stored audio may be progressively streamed for post-production processing and long-term storage and distribution, as described further herein.

A related feature is illustrated in FIG. 18, which shows a pair of tabs for an Internet browser window, including a first tab 142 that is the active window and a second tab 144 that is not the active window. The second tab 144 includes a recording indicator 146 that indicates that that particular page includes an I/O area 138 where a user can record audio. In preferred embodiments, the recording indicator 146 has a non-recording state (e.g., solid red), where no recording is taking place, and a recording state (e.g., flashing red), where a recording is taking place. In this way, a user can (1) easily identify and navigate to browser windows with recording capabilities and (2) know whether recording is taking place or not, including when the browser tab with the record button is not the currently-active window.

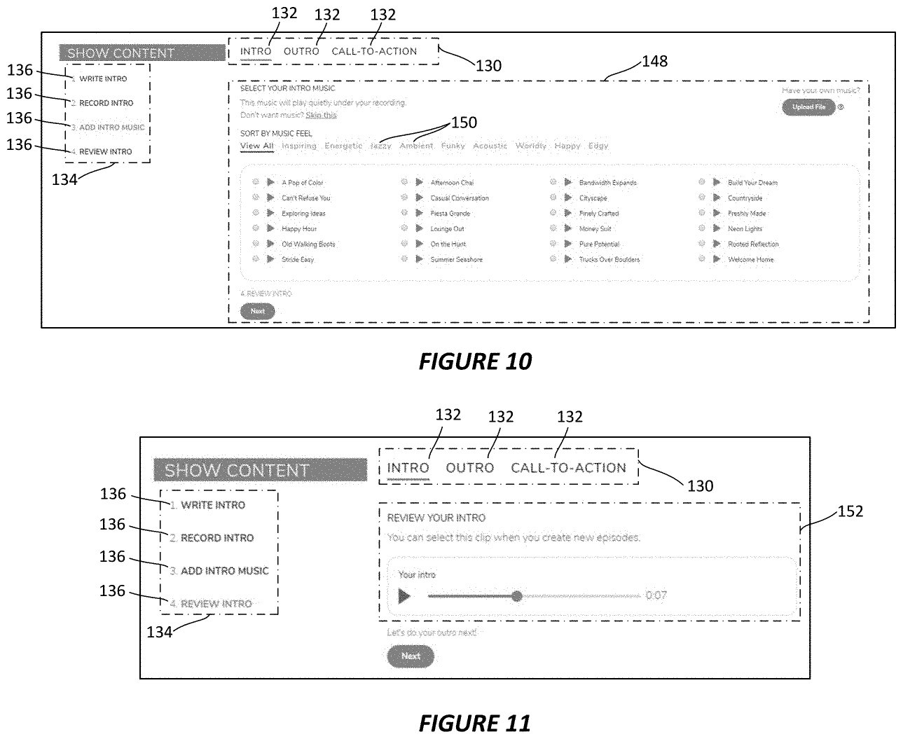

Next, with reference to FIG. 10, while keeping the first element 132 the same (i.e., INTRO) and selecting the next second element 136 (i.e., ADD INTRO MUSIC), the input area 122 and the I/O area 138 are replaced by an optional input area 148 that will optionally allow the user to select a pre-recorded audio track from a list of tracks or to upload a previously-recorded audio track to use as intro music and that will accompany the previously-recorded intro. Preferably, the pre-recorded audio tracks can be filtered based on one or more selectable categories 150. Even more preferably, the system 100 automatically suggests one or more of the pre-recorded tracks or a category based on data previously provided by the user, such as the show categories 120 (FIG. 5).

Finally, with reference to FIG. 11, while keeping the first element 132 the same (i.e., INTRO) and selecting the final second element 136 (i.e., REVIEW INTRO), the optional input area 148 is replaced with output area 152, which will allow the user to hear the previously record audio segments (e.g., the intro and optional music bed or background music) after they have been processed with the Preview module. The Preview module is discussed in greater detail below. Since the final second element 136 was active, selecting the “next” button 154 will automatically select the next first element 132 (i.e., OUTRO) and the first second element 136 (i.e., WRITE OUTRO). The process discussed above is then repeated for each of the first elements 132 to produce each of the globally-applied show sounds 139 (FIG. 1).

As shown in the above examples, the first and second navigation sections 130 and 134 assist the user in navigating between the steps for creating various globally-applied portions of a show. The sections 130, 134 also modify the UI to provide relevant tools and information that the user needs in each of those steps on a single screen, but without providing too much content or information that would overwhelm or confuse the novice. Lastly, sections 130, 134 allow the user to easily customize the global show settings.

As discussed below, audio tracks that are selected and recorded in the Setup module 102 may be further processed and assembled automatically using the Preview module 108, which process step is indicated by the letter “B” in FIG. 1 and is shown in FIG. 3. This process and module is discussed in greater detail below.

Plan Module

Referring again to FIG. 1, after the audio tracks have been processed and assembled following the Setup module and first implementation of the Preview module 108, the reusable content for the show has been generated and saved. The user is then guided through Plan module 104. The appearance, functionality, and structure of the Plan module 104 is similar to the appearance, functionality, and structure of the Setup module 102. A primary difference is that the Setup module 102 is used to create reusable content that is preferably automatically used globally for each episode of a show, whereas the Plan module 104 is used to create content that is episode specific. Preferably, after the Setup module 102 has run once and the global settings for the show have been set up, the user would not need to run that module again when new episodes are created because the global settings would be automatically applied to all episodes by the system 100. On the other hand, the user would run the Plan module 104 each time a new episode is created.

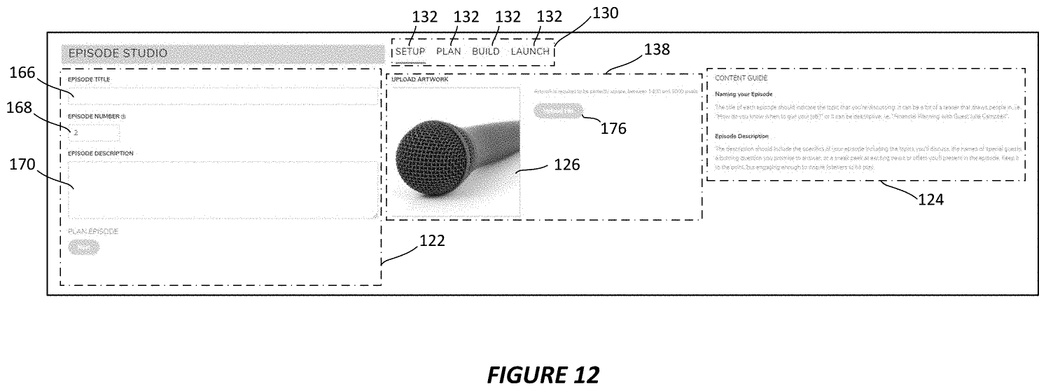

The Plan module 104 assists the user in defining one or more episode plans 158, which plan may include ordering audio segments that will make up the episode and entering related written information. The page shown in FIG. 12 is the first page a user sees when they want to plan and create a new episode and implement the Plan module 104. This page provides first navigation section 130 with first elements 132 for navigating between the various stages of episode production (i.e., setup, plan, record, and review). The “setup” first element 132 is selected and page displays a number of sections for initializing an episode plan. First, input area 122 allows a user to enter an episode title 166, episode number 168 (which is, preferably, automatically assigned or calculated), and episode description 170. It is contemplated that the title 166 or the description 170 could be populated automatically using artificial intelligence (e.g., that transcribes the episodes audio and condenses it to a summary format). Next, I/O area 138 displays the show artwork 126 that was previously selected and gives the user the option to select different artwork, and content guide 124 provides guidance related to naming and describing episodes.

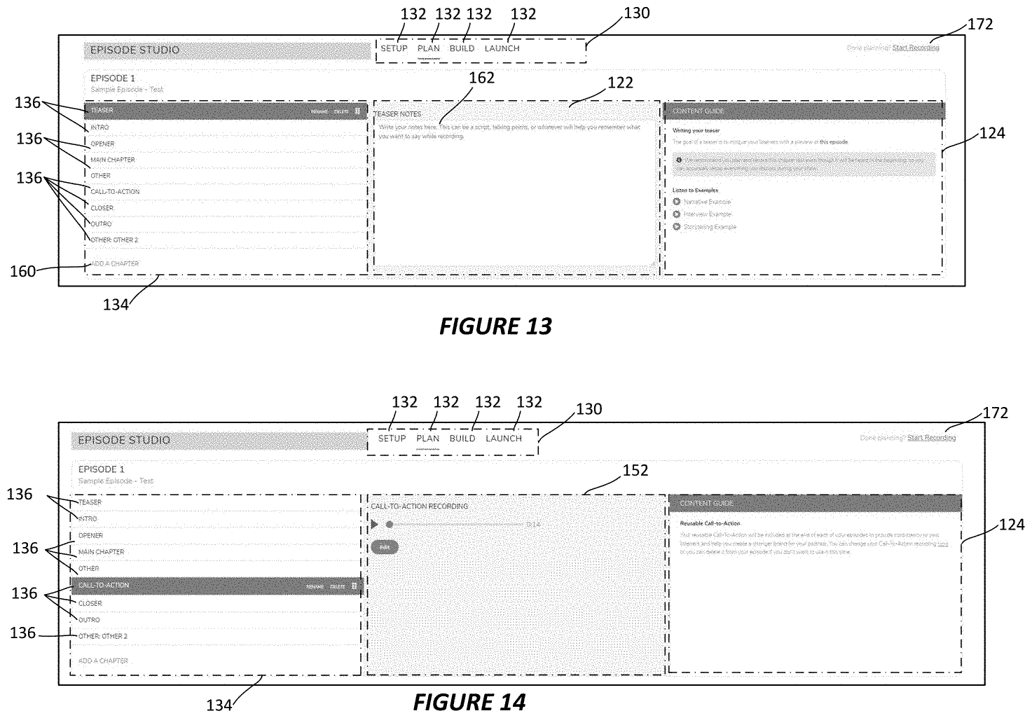

Once the initial setup of an episode is complete, the user then moves on to planning the content of the episode. As shown in FIGS. 13 and 14, certain second elements 136 have been pre-populated based on the previously-created global content (i.e., intro, outro, and CTA). In addition to these, the user has inserted several other second elements 136 using the “Add a Chapter” button 160, including a teaser, an opener, a main chapter, a closer, and other second elements. For each second element 136 created, corresponding pages are created by the Plan module 104 that will allow a user to plan each of those sections. Where appropriate, those pages are provided with an input area 122 and a content guide 124 that is specific to the type of content being created. For example, in FIG. 13, the “teaser” second element 136 is selected and the page includes a notes section 162 in the input area 122 to allow the user to enter the text for a planned teaser for the episode. The page also includes suggestions and examples in the content guide 124 that relate to teasers. Similar pages are also created, each with a corresponding notes sections 162 and content guides 124 for the non-global (i.e., episode specific) content, including the teaser, opener, main chapter, closer, and other.

Preferably, second elements 136 may be re-arranged, added, or deleted by the user. For example, the user might add additional globally-applied sounds, such as advertisements, teasers, etc. by adding additional second elements 136. Additionally, the user may configure the order of the final mixdown. Dragging second elements 136 upwards places them earlier in the final mixdown and dragging second elements downwards places them later in the final mixdown.

Preferably, the user enters the segment or show notes in the input area 122 prior to recording the associated audio file (e.g., show notes may form an outline or script of a proposed interview of a guest with questions to ask). These notes appear in a corresponding input area in the record module, as further described below, that is displayed to the user while recording the audio segment. This assists the inexperienced user that might encounter difficulty in setting up these elements of the audio production, which will be used later and can influence the overall quality of the final product.

Another example is given in FIG. 14, where the “Call-to-Action” second element 136 is selected. Since this CTA content is global and was already created, the input area and notes section are replaced with an output area 152, which allows the user to review the previously-created content. If the user chooses to edit this content, a new window preferably opens and displays the page for creating a CTA. The content guide 124, in this case, notes that this is reusable content and discusses CTAs. Similar pages are also created, each with a corresponding output areas 152 and content guide 124 for the global content (i.e., intro, outro, CTA).

Once the user has planned each section by visiting each of the pages associated with each of the second elements 136, they are ready to record and create the episode-specific content using the record module 106. Lastly, a “Start recording” button 172 will allow the user to bypass the pages associated with the second element 136 and go immediately to the record UI.

Record Module

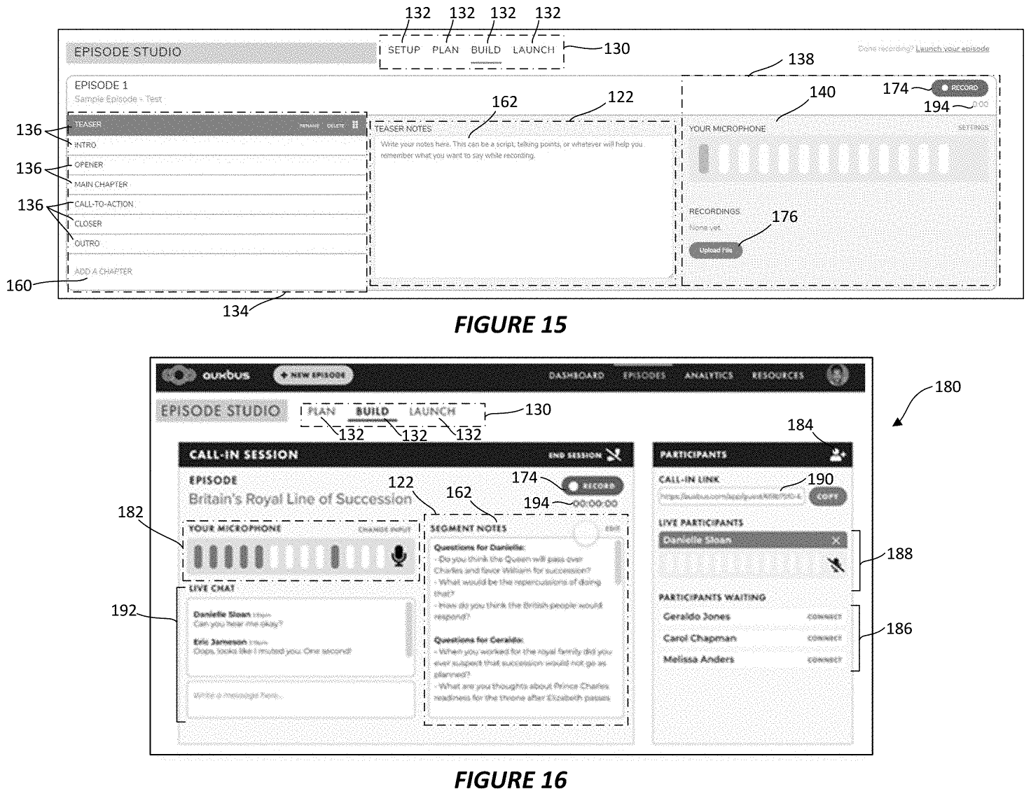

The record module 106 allows a user to record or upload the various episode-specific audio segments that were previously planned using the Plan module 104 one section at a time. The UI tools presented to record audio are preferably influenced by the type of segment of audio being recorded. For example, the UI interface shown in FIG. 15 may be presented to a user that is recording a monologue-type chapter audio segment involving only one participant. On the other hand, the UI interface shown in FIG. 16 may be presented when the chapter segment will include one or more remote guests in addition to the host.

The record UI preferably provides all of the information and tools that a user needs to record a particular audio segment on a single page. In FIG. 15, the user is recording the teaser for the episode. The UI interface displays the previously entered teaser notes in the notes section 162 in the input area 122. The notes section 162 is preferably editable even in the record module to enable the user to update the show notes during the recording session. The I/O area 138 contains volume unit meter 140 to provide visual confirmation to the user that their microphone settings are correct and that the microphone is picking up audio signals. The user can upload a previously-created audio file as the teaser by pressing the “Upload File” button 176. Alternatively, the user can record the teaser by pressing the “record” button 174. A timer 194 displays the length of the current recording. As discussed above, this recording is preferably stored locally to the user's device.

Preferably, the recording UI displays a detected hardware type (e.g., microphone type). In this case, this information is displayed in the I/O area 138. This can be detected automatically (e.g., when using a built-in microphone) or via user indication (e.g., when a user selects a microphone from a drop-down menu listing multiple options). The detected hardware type can be used in automated audio processing. Custom digital signal processing (DSP) and equalization (EQ) appropriate for the type of audio production can be implemented for detected local hardware (e.g., microphone used for recording). For example, default sample rates (e.g., 44100 Hz), channels (e.g., Stereo), bit rates (e.g., 32 bit), and file formats (e.g., uncompressed WAV) can be set for a detected type or class of microphone being used. These settings can be automatically populated for the user and used for recording.

With reference to FIG. 1, certain recordings may involve the host and one or more other remotely-located guests. This could occur, for example, in an interview, debate, etc. between two or more people. In that case, the parties have a real-time discussion with one another. The real-time communication session is made, for example, using VoIP communication that is implemented using WebRTC (web real time communication). In other embodiments, the real-time communication session is made using a teleconference over a wireless network, landline, or the like. The real-time communication session allows the participant(s) and host to communicate (using voice or video chat features).

The real-time discussion is distinct from the local recording of audio used in post-production. A local recording of each party's individual contribution to that discussion is preferably stored locally to that user's device. Each audio track is an isolated recording that contains only the audio of one of the parties to the discussion. For example, the local recording stored to the host's device includes only the host's contribution to the discussion and each of the local recordings stored to each of the guests' devices includes only those guests' respective contributions to the discussion. The isolation and local recording of audio allows each of those isolated tracks to be mixed, improved, blended, etc. separately, which allows a higher quality “complete” conversation (i.e., a combination of all parties' improved contributions to the conversation) to be produced. As discussed below, the resulting isolated audio tracks are processed and assembled together to form a complete audio segment by the Preview module 108.

In certain embodiments, the host record UI 178 presented to the host is different and more robust, including additional information and features, than the guest record UI 180 that is presented to a guest. The UI interface shown in FIG. 16 is an example of a host UI interface 180. Preferably, from these UIs 178, 180, the host and user can each view and change their audio input (i.e., microphone) settings and level from a microphone area 182. The host user can also view and edit segment notes 162 in the input area 122. The guest UI 180 can include all of the features of the host UI, a subset of those features (e.g., show notes 162 are not likely to be needed or desired in the remote or guest UI), or even different features. In certain embodiments, the host UI 178 may include a record button that initiates and halts recording of the guest using the guest's hardware. Alternatively, a remote participant may initiate and halt recording locally via the guest UI 180 via a similar record button.

In certain preferred embodiments, host and remote guest audio may be recorded from an in-session UI that joins participants in a real-time session. In those cases, a session invite 190 must be provided by the host to the guest before the guest will be allowed to interact with the show, including recording audio segments for that particular segment. The session invite may be a URL link to a particular webpage associated with the show, a particular phone number associated with the show, or other similar devices. The user interacts with (e.g., clicks on) the session invite and is then taken to a call-in session interface for recording. The session invite is preferably shareable via multiple channels, including via email, text, etc. An add participant button 184 allows a host to create a call-in link 190 (e.g., a URL), which may then be transmitted to one or more guests. The session invites may be generic to all guests or may be specific to a particular guest. The remote guest uses the join link to be added to the session.

After being added to the session, the remote guest preferably initially appears in a waiting area 186 of the host UI 178. The waiting area 186 allows the host to interact with the participants. For example, a chat area 192 may be provided in both the host UI 178 and guest UI 180 to allow the parties to communicate with one another. Preferably, a transcript of the chat is automatically captured and saved by the record module 106 and may be appended to that chapter's notes in record and Plan modules. Also, while in the waiting area 186, participants can be passed audio (e.g., on-hold music, show tips, etc.). A participant may leave a voice message rather than waiting to be joined. For example, an auto-attendant may handle the participant's inputs and allow recording of a voice message. This voice message may be transcribed automatically, e.g., using natural language processing, to provide the host with a transcript of the audio. This may assist the host in determining whether the remote participant should be joined to the recording session, whether the voice file should be played during the recording session, or whether the voice file should be added after the recording session in a post-production step. This text Preview of the recording may have applicability to live radio or other applications. Guest may be connected to the real-time communication session by the host and guests that have been connected appear in the live participant area 188 and have their audio recorded. Guests' microphone levels preferably may be monitored, adjusted, and muted when they are in either the waiting or live participant area 186, 188.

Once audio segments for each of the non-global second elements 136 (FIG. 15) have been recorded, they are processed and assembled with the previously recorded and processed global second elements via a second implementation of the Preview module.

Preview Module

After the show has been initialized using the Setup module 102, as discussed above, several individual audio components have been created or selected for the show. For example, one or more audio tracks, recorded by the user, may be associated with each of the intro, outro, and CTA portions. These audio tracks may include, for example, voice tracks containing audio dialog. Additionally, the user may have optionally also selected pre-made background music or uploaded their own background music for each of the intro, outro, and CTA portions. With reference to FIGS. 1 and 3, one or more of these audio tracks may be stored and streamed from a provider storage 196, such as offsite or cloud storage. As discussed above, one or more of these audio tracks may be stored locally to a user or host device (at least temporarily). Preferably, these separate audio tracks undergo post-processing to improve their quality and are then combined together to form the final intro, outro, and CTA tracks that will be used globally in the show via a first implementation of the Preview module 108. Similarly, after the show has been recorded using the record module 106, as discussed above, several additional individual audio components have been created or selected for a particular episode of a show. This may include, for example, one or more audio tracks, recorded by a host and guests. Preferably, these separate audio tracks undergo post-processing to improve their quality and are then combined together to form the final intro, outro, and CTA tracks that will be used globally in the show via a second implementation of the Preview module 108.

The Preview module 108 is preferably a remote (e.g., cloud-based) module provided by a provider that implements two main functions: auto processing of audio segments and auto assembly of audio segments. When implemented following the Setup module 102, these functions take the various user supplied-inputs discussed above (i.e., raw audio files recorded locally, music selections, ads, etc.), which are sequenced according to a user's choices in the Setup module 102 and produce, as an output, an audio file of the finished audio segment (i.e., finished intro, finished outro, finished CTA). When the Preview module 108 is implemented following the record module 106, the Preview modules takes the various user supplied-inputs discussed above (i.e., raw host/guest files recorded locally, music selections, ads, etc.), which are sequenced according to the Episode Plan in the Plan module 104 and produce, as an output, an audio file of the finished audio production that is suitable for distribution.

Implementing the Preview module 108 initiates an Auto Processing Module 198 and an Auto Assembly Module 200 and starts automatic post-processing on the audio tracks and assembly of the final compiled audio production. The Auto Processing and Auto Assembly Modules 198, 200 are illustrated separately for ease of description, but the functionality described below could be implemented in more or fewer modules. The Preview module 108 will be described collectively and it includes automated functions of a multi-track digital audio workstation (DAW), relieving the inexperienced user from the need to handle the processing, editing and mixing of the audio files.

Generally, the Auto Processing Module 198 operates on the digital audio files to improve their sound quality using sound repair or recovery techniques. This includes applying predetermined processing of the audio such as normalizing the audio files' sound levels, applying noise filters, and applying fade techniques to boundary areas of the audio files. Further, editing techniques are applied in an automated fashion (e.g., padding or trimming audio files for proper alignment). Automated mixing techniques are also applied. For example, if background music is selected by the user, Auto Processing Module 198 combines the background audio with speech track audio. In another example, where separate audio tracks (e.g., speech audio) from a host and remote guest are provided, Auto Processing Module 198 mixes those files at appropriate sound levels to ensure speech audio quality.

After the individual segment files have been prepared, the Auto Assembly Module 200 assembles (i.e., stitches together) the processed audio files using an automated algorithm that adheres generally to the user's inputs (in terms of general sequencing), applies cross fades to segment transitions, and outputs a professional level output file, which again undergoes processing (e.g., target volume adjustment), and includes metadata gathered during the planning stage (e.g., title, description, and artwork).

By way of specific example, Auto Processing Module 198 acts as an automated multi-track editing software and applies a predetermined set of configurations optimized for audio track post-production according to a predetermined set of algorithms designed to improve the audio quality and prepare the audio segments for joining in a step-wise fashion. The algorithm may vary depending on the type of audio production (e.g., podcast vs. audiobook). Examples of preset configurations applied in sequence include first applying sound leveling or normalization to a target amount. This adjusts the amplitude of the audio, e.g., raising the volume of speakers in the audio, but can also increase the level of unwanted sound (undesirable imperfections, which will make these easier to later remove). For example, a track with audio below a particular threshold amplitude may be normalized to bring its amplitude up to a normalized, target level. Automatic amplitude levelling can be applied to the audio files to account for differences between speakers (e.g., a local host and remote guest that need to be normalized for sound levels). For example, after recording an episode, the speech amplitude is automatically adjusted to a target level (e.g., adjusting all peaks to a target level). This delivers consistency between different people speaking in the output audio file. In a related manner, Auto Processing Module 198 can adjust the amplitude of audio files or tracks in a relative manner. For example, when adding in a music file as a music bed, it may occur that the amplitude of the music file is too loud. This can cause poor audio quality in the final audio file, particularly if the conversation level is low. Therefore, in addition to adjusting conversational tracks, related tracks can have their amplitude adjusted in a relative manner.

Dynamic processing (e.g., compression) and reduction of noise using one or more filters (e.g., to remove common sources of noise such as rumble, hum, and DeEssing) may then be applied. Auto Processing Module 198 applies a program or algorithm to each audio file individually or after one or more audio files are combined together. For example, high and low pass filters may be used to remove unwanted noise frequencies outside the range of human speech. A predetermined selection of such filters may be employed to reduce unwanted noise in the audio files.

Short fade ins and outs can be applied to each segment to reduce occurrences of unwanted sounds (e.g., pops) due to immediate signal starts and stops. Similarly, Auto Processing Module 198 may insert padding (i.e., silence) into an audio file to adjust its timing (e.g., relative to another track). This is utilized, for example, in ensuring that a remote guest's locally recorded file starts at a predetermined time with respect to the host's audio file (e.g. guest's answer naturally follows a host's question). This allows the files to be more precisely aligned with one another. This faun of adjustment would be particularly useful, for example, with Q & A interviews, where the parties to the discussion are not responding to one another in real time. In that case, the conversation must be constructed from recorded questions that are answered at a later time or date and where padding is inserted into the final mixdown in order to correctly time align the audio tracks.

In order to prepare the music bed, the Auto Processing Module 198 may sample the music selected by the user to prepare a shorter clip, which is normalized and has fades added (e.g., at the beginning) As above, the speech track (to be paired with the audio) is normalized to the music track (e.g., using a target value) to ensure that the music is at an appropriate volume level as compared to the speech volume level. The speech track and music track are paired or mixed to form a combined file.

After processing to adjust gain and remove noise, a volume adjustment may be performed for the tracks to a target loudness, e.g., −16 LUFS. Volume adjustment may be repeated at various points in the processing.

In addition, the Preview Module 108, via the Auto Assembly Module 200, automatically assembles the segments. Generally, the segments are assembled using a series of crossfades between each segment. This assembles the segments in a linear ordering, as follows: segment 1<crossfade>segment 2<crossfade>, etc. If not already done, the segments may need to be trimmed or padded, which can be accomplished by determining their length and then applying a function that adjusts a segment at a predetermined point (e.g., at a point determined to allow for room for a given segment, such as an outro segment).

After assembling the final audio file, the Auto Assembly Module 200 inserts file metadata (e.g., podcast title, episode number, etc., as provided by the user in the planning stage), chooses a file format, e.g., Wave PCM, MP3, etc., and selects the format settings (e.g., 256 kbps or 160 kbps, 44100 Hz MP3 settings). The Auto Assembly Module 200 populates ID3 tag data, which contains the creator name, title, year and genre of the audio file, along with the selected podcast artwork. In one example, an uncompressed master file is saved along with a compressed version for distribution (e.g., MP3).

In summary, a template of preconfigured settings is applied to process the audio files and clean them up in a predetermined, ordered fashion. This is followed by a step-wise joining of segments together according to the record plan, with additional normalization to a target sound level. Thereafter, a final audio file is output in a compressed format with appropriate metadata for placement on a distribution platform.

In certain embodiments, artificial intelligence is used to assist or improve certain automated processing or assembly steps. For example, machine learning may be applied to increase the accuracy of the sound processing applied (e.g., intelligently select presets such that noise removal presets are matched to those previously used; intelligently selects words such as crutch words, bad words for removal; etc.)

The coarse level editing decisions made by the inexperienced user in the planning phase, (i.e., the user selections of the linear sequence of audio files), dictate the ordering with which the files are assembled by the Auto Assembly Module 200, with additional audio processing and editing applied automatically for the user. Therefore, at least part of the automated production processing is linked to the user inputs (e.g., supplied via the Setup, Plan, or record UIs). The Preview Module 108 modifies the audio inputs using sound optimization techniques (e.g., sound leveling, equalization, noise reduction, filtering), editing techniques (e.g., trimming, addition of fades, etc.) and mixing techniques (e.g., addition of music bed to speech input files).

Review Module

After the final audio tracks have been produced, the final steps are to assemble the episode, via the Auto Assembly Module 200 (FIG. 3) and to distribute the assembled episode according to the user's distribution settings 128 (FIG. 1) via an Auto Distribution Module 202 (FIG. 4) to the user's selected distributor platforms 202.

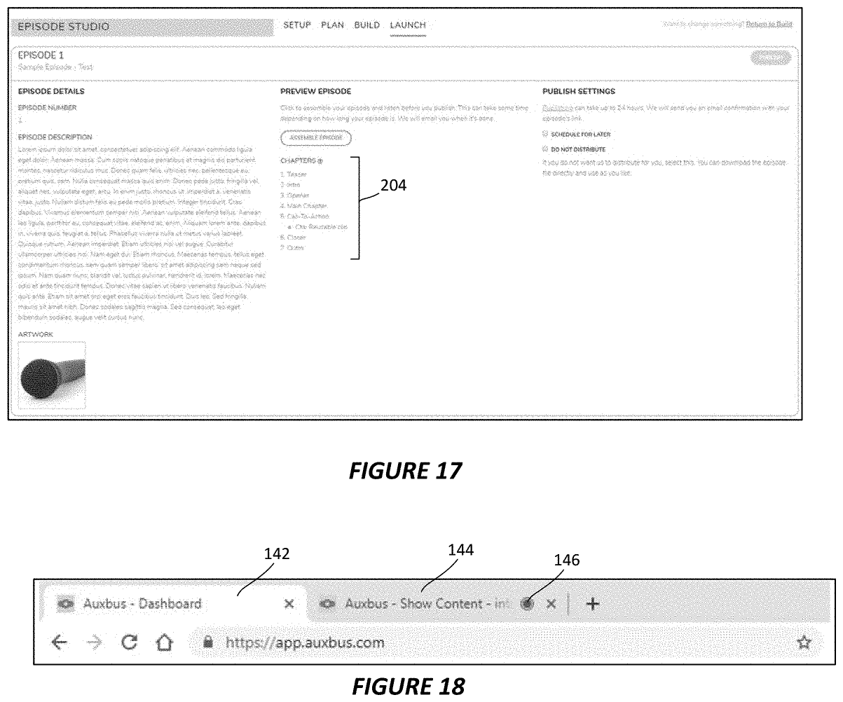

An exemplary review UI is shown in FIG. 17. The review UI displays the logical layout 204 of the audio files as assembled by the user. In the illustrated example, the layout includes the following segments, which will be assembled in the following order:
a. Teaser;
b. Intro;
c. Opener;
d. Main Chapter;
e. Call-To-Action (based on a reusable sound file);
f. Closer; and
g. Outro.

Each item in the list may be associated with an audio file that will be used in post-production. Because the ordering of the segments will impact the order and overall sound of the final audio production, if a user wishes to rework any parts of the audio production, e.g., re-record a segment, reorder the segments, etc., the user can return to a prior part of the UI (e.g., the Setup or record module) to accomplish the same. This can be accomplished before or after the audio production is assembled. Although the Auto Assembly Module 200 is shown as part of the Preview Module 108 in FIG. 3, the assembly step may occur prior to or at the same time as the implementation of the Review Module 110. The review UI also indicates data obtained from prior user inputs, e.g., publish settings include timing information for when the podcast will be published, obtained from a prior step in the UI (e.g., planning UI or setup UI).

Modularity

The functions of the system described above can be modularized and may be used in a variety of other contexts. For example, while the end-to-end system represents one example implementation of the current technology, various parts of the technology (e.g., the automated processing technology) may be decoupled from other module(s) (e.g., the planning module) to make the decoupled modules applicable to different contexts and intended uses. For example, the planning module may be less relevant to the recording of an audiobook when compared to recording an interview or Q&A type audio production. The modules may be modified to accommodate different contexts and intended uses (e.g., producing different audio, such as for an audiobook or audio for a video production). For example, the modules may be modified to display different information to the user (e.g., different planning modules) or incorporate different presets (e.g., automate post-production using a set of audiobook presets instead of podcast presets).

Several enhancements are possible in which the various UI views may be configured to provide supplemental information to the user, particularly the host user, in order to facilitate successful audio creation. Some of these feedback tools may be influenced by data gathered from the platform.

For example, estimates of the preferred time (i.e., duration) for given segments (e.g., intro segment) can be displayed to the user with a corresponding static estimate of the number of words. This will assist the user in planning (i.e., scripting) a segment and having it result in an audio file of suggested optimal duration, prior to recording it. These suggestions are preferably presented in the input area 122 or content guide 124 of the setup or planning UI (See FIG. 2). It is possible to include dynamic feedback, such as a spoken word-to-time converter, for calculating the estimated amount of time the entered text will require to read. This offers a user with dynamic feedback indicating whether the scripted part (i.e., the text entered into a text entry field of the browser by the user) is predicted to be of the appropriate length. This allows a user to estimate if the segment is going to have the appropriate length of audio when recorded, particularly taking into account any extra time needed for post-production activities (e.g., placing music at the beginning or end of the audio segment). By way of example, while scripting an introduction, a user could be informed (e.g., via pop up message or other indicator) that an audio segment must be concluded with enough time to include an ending card or music transition.

The data used for these estimates (e.g., appropriate duration for an intro segment, etc.) may be predefined, obtained from another source, dynamically updated, or a combination of the foregoing. For example, if metrics are being recorded and analyzed across the platform, highest rated audio productions may be analyzed to determine an optimum time for a particular segment. This data may be used to adjust the feedback given to the host user attempting to script and record a new segment so that the host is aware of prior successful segment metrics.

In another example, the platform could also be configured to gather data related to audio-focused metrics and to provide that data back to hosts to assist in collaboration and improving audio productions. Identifying appropriate guests (or other participants) has conventionally been difficult for inexperienced creators. Most existing forms of social media tend to focus on visual content (e.g., picture posts), which is difficult to consume in certain areas (e.g., in a car), and do not focus on audio production. Thus, matchmaking for the purpose of creating an audio-based product (e.g., a podcast) via a picture-based or visual-based social media platform is difficult. Thus, the social networking platform of the present invention can be used in matchmaking between hosts and guests. This would enable hosts to be matched with guests that meet certain criteria (e.g., expertise, area of interest, rating, etc.). Preferably, the platform includes an identity verification system (similar to block chain identity verification) that would assist users in verifying the identity of guests and participants prior to including them in a show. This could be implemented via assigning or recognizing a unique identity for users of the platform, such as user-specific session invites, and associating the unique identity with a verified guest or type of guest (e.g., an expert in a given topic, a highly-rated guest or podcast producer, etc.)

Feedback may be provided by the platform (e.g. number of listens and downloads, user ratings) as well as by other users (i.e., content creators) of the platform that form a social network and that provide feedback after listening to audio content on the platform. Feedback from other users of the platform may include audio quality scoring, such as a lack of crutch word usage, use of quality hardware (e.g., microphones used by remote guests) and the like. A scoring system could be tied to the above-described metrics within the platform to award creators, guests or participants with currency (e.g., crypto currency) that is usable within the platform or outside of the platform. This could create an opportunity for generating revenue via use of the platform by producing high quality or well received audio content.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A method for creating a digital audio production comprising the steps of:
receiving two or more audio segments, including at least one audio segment that is captured by a sound recording device;
receiving user input related to the two or more audio segments;
receiving a record plan comprised of a first part that is based on the user input and a second part that is determined automatically based on the user input; and
recording said digital audio production from the two or more audio segments based on the record plan.

2. The method of claim 1 wherein first part of the record plan comprises a chronological ordering of at least a portion of the two or more audio segments in the digital audio production after the recording step.

3. The method of claim 1 wherein the second part of the record plan comprises audio processing steps that are determined and configured automatically based on user input.

4. The method of claim 3 further comprising the step of automatically applying the audio processing steps to at least one of the two or more audio segments prior to the recording step, based on the second part of the record plan.

5. The method of claim 3 further comprising the step of automatically applying the audio processing to the digital audio production following the recording step, based on the second part of the record plan.

6. The method of claim 1 further comprising the steps of:
compressing the digital audio production to form a digital file suitable for digital distribution;
digitally distributing the digital file according to the user input.

7. The method of claim 1 further comprising the step of:
storing the at least one audio segment captured by the sound recording device to local storage that is local to the sound recording device; and
wirelessly transmitting the at least one audio segment from the local storage to remote storage prior to the recording step.

8. The method of claim 7 wherein the local storage is a memory of the sound recording device.

9. The method of claim 1 further comprising the step of providing a display device configured to display a user interface (UI) and a user input device for receiving the user input.

10. The method of claim 9 wherein the user interface comprises functional elements associated with the two or more audio segments and wherein the position of the functional elements within the UI determines the chronological ordering the two or more audio segments.

11. The method of claim 9 further comprises providing a host UI and a host user input device configured to receive input from a host and providing a guest UI and a guest user input device configured to receive input from one or more guests.

12. The method of claim 11 wherein content of the host UI differs from content of the guest UI.

13. The method of claim 11 further comprising the step of providing a session invite to each of the one or more guests before the guest UI is provided to the user.

14. The method of claim 10 further comprising the step of receiving user input via the user input device to reposition the functional elements within the UI for modifying the chronological ordering of the two or more audio segments.

15. The method of claim 10 further comprising the step of displaying a content guide in the UI for displaying information associated with the functional elements that are currently displayed in the UI.

16. The method of claim 1 wherein at least two of the two or more audio segments are captured by separate sound recording devices, wherein the at least two audio segments are stored locally to a local storage of each of the sound recording devices, and wherein the at least two audio segments are wirelessly transmitted to a remote storage and are then processed according to the record plan.

17. The method of claim 1 further comprising the step of creating two or more individual episodes of the digital audio production, wherein each episode comprises a first audio segment that is universal to all of the two or more episodes and separate second audio segments that are unique to each of the two or more episodes.

18. The method of claim 17 further comprising the steps of:
after creating two or more individual episodes of the digital audio production, modifying the record plan to replace the first audio segment with a new first audio segment; and
re-creating the two or more individual episodes of the digital audio production, wherein each episode comprises the new first audio segment that is universal to all of the two or more episodes and separate second audio segments that are unique to each of the two or more episodes.

19. A digital audio file comprising:
two or more audio segments combined according to an ordering of the two or more audio segments that is specified by a user,
wherein at least one of the two or more audio segments is audio processed, using predetermined audio processing steps that are determined automatically in response to receipt of the ordering of the two or more audio segments, prior to being combined with another one of the two or more audio segments, and
wherein the ordering does not include any audio processing steps.

20. An audio production and distribution system for creating and distributing a digital audio show comprising two or more related but separate episodes, the system comprising:
a processor and a storage device, wherein the storage device stores instructions executable by the processor to execute:
a setup module for receiving show-level user input related to show-level portions of the show that are repeated in each episode;
a plan module for receiving episode-level user input related to episode-level portions that are unique to each episode of the show and for arranging show-level portions and episode-level portions according to a record plan;
a record module for receiving recorded show-level audio segments and recorded episode-level audio segments;
a preview module for audio processing recorded audio segments, for ordering and combining the recorded audio segments to form an unprocessed episode, and for audio processing unprocessed episodes to form finished episodes; and
a review module for distributing finished episodes.
